(19) United States
(12) Patent Application Publication
(10) Pub. No.: US 2016/0094889 A1
(43) Pub. Date: Mar. 31, 2016

(54) SYSTEMS AND METHODS FOR DETERMINING WHETHER TO MERGE SEARCH QUERIES BASED ON CONTEXTUAL INFORMATION

(71) Applicant: Rovi Guides, Inc., Santa Clara, CA (US)

(72) Inventors: Sashikumar Venkataraman, Andover, MA (US); Ahmed Nizam Mohaideen P, Tamilnadu (IN)

(21) Appl. No.: 14/500,309

(22) Filed: Sep. 29, 2014

(51) Int. Cl. H04N 21/482; G06F 17/30

(52) U.S. Cl. CPC H04N 21/4828; G06F 17/30498; G06F 17/30528

(57) ABSTRACT

The systems and methods discloses herein determine whether to merge search queries used to identify a media asset among a plurality of media assets. A first identifier may be assigned to a first search query from a user. The systems and methods may further determine a plurality of identifiers based on a mapping that associates the first identifier with the plurality of identifiers, wherein each of the plurality of identifiers corresponds to a search query that has previously been merged by the user with the first search query to perform a search. A second identifier may then be assigned to a second search query, and it may be determined whether to merge the first search query and the second search query based on whether the second identifier is among the plurality of identifiers. A search of the plurality of media assets may then be performed based on the determination.

### BACKGROUND OF THE DISCLOSURE

Users who search for media assets on interactive media systems often desire that these systems be able to make inferences about how search queries relate to one another. For example, a user may issue two search queries and expect the interactive media system to determine automatically from contextual information when to merge the search queries and when to disassociate them. However, conventional systems lack such features and typically require users to issue control commands that provide explicitly the relation between search queries. Accordingly, such conventional systems are inconvenient to use, especially when users provide input to the interactive media system using voice commands, and lack an effective mechanism for determining whether to merge or disassociate search queries.

### SUMMARY

Accordingly, systems and methods are described herein for determining whether to merge search queries used to identify a media asset among a plurality of media assets based on contextual information. In some aspects, the systems and methods may receive a first search query from a user. The first search query may be used to access a mapping that associates search queries previously input by the user with other search queries that have previously been merged by the user with the first search query to perform a search. Upon receiving a second search query, the systems and methods may thus determine whether to merge the first search query with the second search query based on whether the first search query is associated with the second search query in the mapping.

For example, a user may desire to locate a media asset among a plurality of media assets by issuing a first search query (e.g., “locate James Bond movies”). The first search query may be input by the user using a voice command that is converted to a text string using automatic speech recognition techniques. In response to receiving the first search query, the systems and methods may search a plurality of media assets based on the search query and generate a display of media assets that match the first search query. Alternatively or additionally, the search results may be played back to the user or output in any other suitable form. The interactive media system may further access a mapping (e.g., a hash table or other suitable data structure) using the first search query to determine other search queries that have previously been merged with the first search query by the user. For example, in a previous search, the user may have refined his or her search for James Bond movies by looking only for those James Bond movies that star the actor Sean Connery. Accordingly, if the user chooses to issue a second search query (e.g., “Sean Connery”), the systems and methods may determine whether the search query “Sean Connery” has previously been merged with the search query “James Bond movies” to perform a search. If the systems and methods determine that the user indeed perform a search previously that associated “James Bond movie” with “Sean Connery,” the systems and methods may determine to merge the first search query and the second search query and perform a search based on the merged search queries. In other words, the systems and methods may determine that contextual information associated with the first search query and the second search query is sufficiently similar, and that, therefore, the user likely intended to perform a search based on the merged search queries.

In another example, the user may issue a first search for “James Bond movies,” and the systems and methods may similarly determine a set of search queries that have previously been merged with the first search query (e.g., James Bond movies). The user may then issue a second search query for media assets that have “comedy” as their genre. In response to receiving the second search query, the systems and methods may determine whether the user has previously performed a search for James Bond movies that fall under the comedy genre. If the systems and methods determine that such a search has not been performed previously, the systems and methods may determine that the user did not intend the first search query and the second search query to be merged, but rather intended to issue a new search based solely on the second search query, i.e., media assets that fall under the comedy genre. In other words, the systems and methods may determine that a “context switch” has occurred and may accordingly determine that a merging of the first search query and the second search query is not appropriate.

In some aspects, the systems and methods may assign a first identifier to the first search query, and may determine a plurality of identifiers, wherein each of the plurality of identifiers corresponds to a search query that has previously been merged by the user with the first search query to perform a search. In some implementations, the systems and methods may determine the plurality of identifiers from a mapping that associates the first search query with the plurality of identifiers. Upon receiving a second search query, the systems and methods may similarly assign a second identifier to the second search query. The systems and methods may then determine whether to merge the first search query and the second search query based on whether the second identifier is among the plurality of identifiers.

For example, the user may input a first search query to look for James Bond movies. In response to receiving the first search query, the systems and methods may assign a first identifier to the search query, such as “movie series.” The systems and methods may then access a mapping using the first identifier (e.g., “movie series”) rather than the first search query itself (e.g., “James Bond movies”). In this way, the systems and methods may be able to infer whether to merge the first search query with the second search query based on previous instances in which the user decided to merge similar, though not identical, search queries. For example, the system and methods may subsequently receive a second search query for movies featuring the actor Sean Connery. Based on the second search query, the systems and methods may assign the second search query a second identifier, such as “actor.” Finally, the systems and methods may determine whether the second identifier (e.g., “actor”) is among a plurality of identifiers that have previously been merged with the first identifier in a search performed by the user, and merge the first query and the second search query if the second identifier is indeed among the plurality of identifiers. For instance, the user may have previously performed a search for “Mission Impossible” movies (e.g., the first search query) that star the actor Tom Cruise (e.g., the second search query). Similar to the discussion above, the systems and methods may have assigned a first identifier of “movie series” to the first search, and a second identifier “actor” to the second search query. The user may have subsequently issued a command to merge the first search query (e.g., “Mission Impossible”) with the second search query (e.g., “Tom Cruise”). Accordingly, the systems and methods may have determined to merge the search terms “James Bond” and “Sean Connery” based on determining that another search for “Mission Impossible” and “Tom Cruise” has previously been merged by the user.

In another example, the systems and methods may determine, based on the identifiers assigned to the search queries, that the first and the second search query should be disassociated, i.e., that it should not be merged. For instance, a user may input a first search query to look for James Bond movies. In response to receiving the first search query, the systems and methods may assign a first identifier to the search query (e.g., “movie series”) as discussed in the previous example. Next, the user may provide a second search query, such as the genre “comedy.” The second search query may be assigned the identifier “genre,” and the systems and methods may determine whether the user has previously performed a search in which the identifiers “movie series” and “genre” have been merged. If it is determined that such a merge has not previously been performed by the user, the systems and methods may determine that the first search query and the second search query should not be merged, and that a search should be carried out solely based on the second search query.

In some aspects, the systems and methods may determine whether to merge the first search query and the second search query based on a first mapping, and whether to disassociate the first search query and the second search query using a second mapping. For example, upon assigning a first identifier to the first search query, the systems and methods may assign a first identifier to the first search query and use the first identifier to determine a first plurality of identifiers and a second plurality of identifiers. The first plurality of identifiers may be determined based on a first mapping that associates the first identifier with identifiers that have previously been merged by the user with the first search query. The second plurality of identifiers may be determined based on a second mapping that associates the first identifier with identifiers that have previously been disassociated by the user from the first search query. Upon receiving a second search query, the systems and methods may assign a second identifier to the second search query. If the second identifier is among the first plurality of identifiers, the systems and methods may determine that the first search query and the second search query should be merged. Alternatively, if the second identifier is among the second plurality of identifiers, the systems and methods may determine that the first search query and the second search query should be disassociated.

In some aspects, a mapping that associates a first identifier with a plurality of identifiers may take into account search queries that have previously been merged by other users. For example, the systems and methods may generate the mapping based on search queries issued by users in the same household as the user, users living in a same geographical region, users with similar demographic background, users that are associated with one another through a social network, etc. Such an expanded mapping that takes into account merge or disassociation decisions from other users may be useful because they provide a larger amount of input data for inferring contextual information from the search queries.

In some aspects, the systems and methods may generate for display the first search query, the second search query, and an indication of whether the first search query and the second search query are to be merged. The systems and methods may further receive input from the user that confirms or rejects the determination of whether to merge or disassociate the search queries. The mapping that associates the first search query or first identifier with the plurality of search queries or identifiers may be modified based on the input from the user.

For example, the systems and methods may use a graphical user interface to generate a display of the first search query and the second search query, together with respective tags that reflect the first identifier associated with the first search query and the second identifier associated with the second search query. The graphical user interface generated by the systems and methods may further include search results, which may be updated automatically as the first search query, the second search query, and possibly any additional search queries are received.

In some implementations, the graphical user interface may include one or more buttons that enable the user to override or correct a determination to merge or disassociate the first search query and the second search query. For example, the systems and methods may display an indication that the first search query (e.g. “Mission Impossible”) has been merged with the second search query (e.g., “Tom Cruise”). In response to generating for display such an indication, the systems and methods may receive input from the user that rejects the merge of the first search query and the second search query. Upon receiving such user input, the systems and methods may disassociate the first search query and the second search query. Alternatively, the user may provide input that confirms the merge of the first search query and the second search query, even though such a merge has already been performed automatically. The confirmation by the user may be used by the systems and methods to update the mapping among search queries, and such an updated mapping may enable the systems and methods to make more accurate inferences about whether to merge future search queries based on contextual information.

In some implementations, the systems and methods may update the mapping between search queries only upon receiving input from the user that confirms or rejects the merge or disassociation of the first search query and the second search query. Performing such an update only in response to user input may ensure that the search query mapping reflects only instances of mergers or disassociations that the user intended to occur. Alternatively or additionally, the systems and methods may determine to update the search query mappings when the user fails to override an automatic merge or separation, or if the user chooses to select one of the search results that resulted from the automatic merge or separation of the search queries.

In addition to determining whether a first search query is associated with a second search query in a search query mapping, the systems and methods may further take into account weights associated with such associations in the search query mapping. For example, a weight may be assigned to any connection between a first search query and a second search query in the mapping. In response to assigning a first identifier and a second identifier, corresponding to the first search query and the second search query respectively, the systems and methods may retrieve the weight and compare it to a predefined or dynamic threshold. In some aspects, if the retrieved weight is above the threshold, the systems and methods may determine that the first search should be merged with the second search query. Conversely, if the retrieved weight is below the threshold, the systems and methods may determine that the first search query should be disassociated from the second search query.

For example, similar to a previous example, the user may have issued a first search query for “James Bond movies” and a second search query for “Sean Connery.” Accordingly, the systems and methods may access a first identifier, corresponding to James Bond, in the search query mapping, and retrieve all identifiers that have previously been merged with this first identifier. These identifiers may include “Sean Connery,” “tonight,” “action movie,” etc. Each of these associations may be associated with a weight, such as “0.9”, “0.5”, “0.3”, etc. Since the second identifier corresponds to “Sean Connery,” the systems and methods may retrieve the weight that corresponds to this identifier (e.g., “0.9”). This weight may then be compared to a threshold. If the weight is above the threshold, the search queries may be merged; otherwise, they may be disassociated.

### BRIEF DESCRIPTION OF THE DRAWINGS

The above and other objects and advantages of the disclosure will be apparent under consideration of the following detailed description, taken in conjunction with the accompanying drawings, in which like reference characters refer to like parts throughout, and in which:

FIGS. 1 and 2 show illustrative display screens that may be used to provide media guidance application listings in accordance with some embodiments of the present disclosure;

FIG. 3 shows an illustrative user equipment device in accordance with some embodiments of the disclosure;

FIG. 4 is a diagram of an illustrative cross-platform interactive media system in accordance with some embodiments of the disclosure;

FIG. 5 shows an illustrative graphical user interface that may be used to determine whether to merge search queries based on contextual information, in accordance with some embodiments of the disclosure;

FIG. 6 shows a knowledge graph that illustrates contextual information used for determining whether to merge search queries, in accordance with some embodiments of the disclosure;

FIG. 7 is an illustrative block diagram of an interactive media system for determining whether to merge search queries based on contextual information, in accordance with some embodiments of the disclosure; and

FIGS. 8A and 8B show a flow chart of illustrative steps involved in determining whether to merge search queries based on contextual information, in accordance with some embodiments of the disclosure.

### DESCRIPTION

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

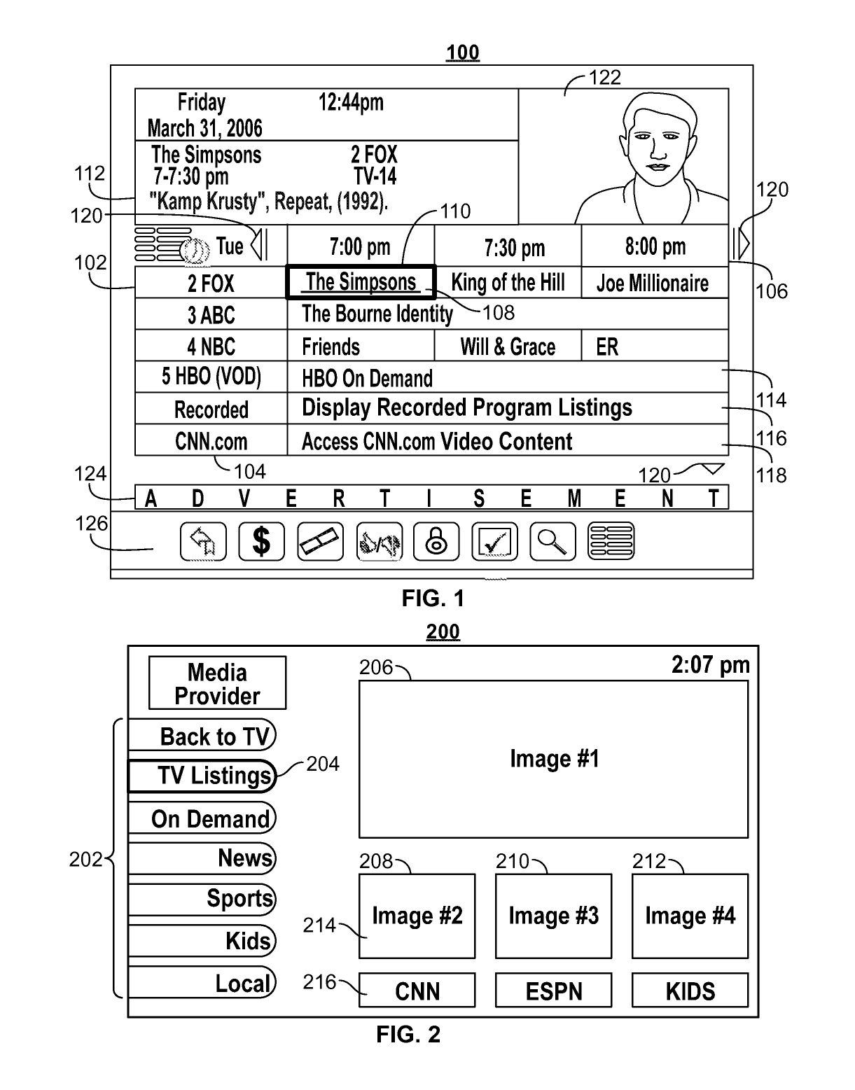

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows an illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

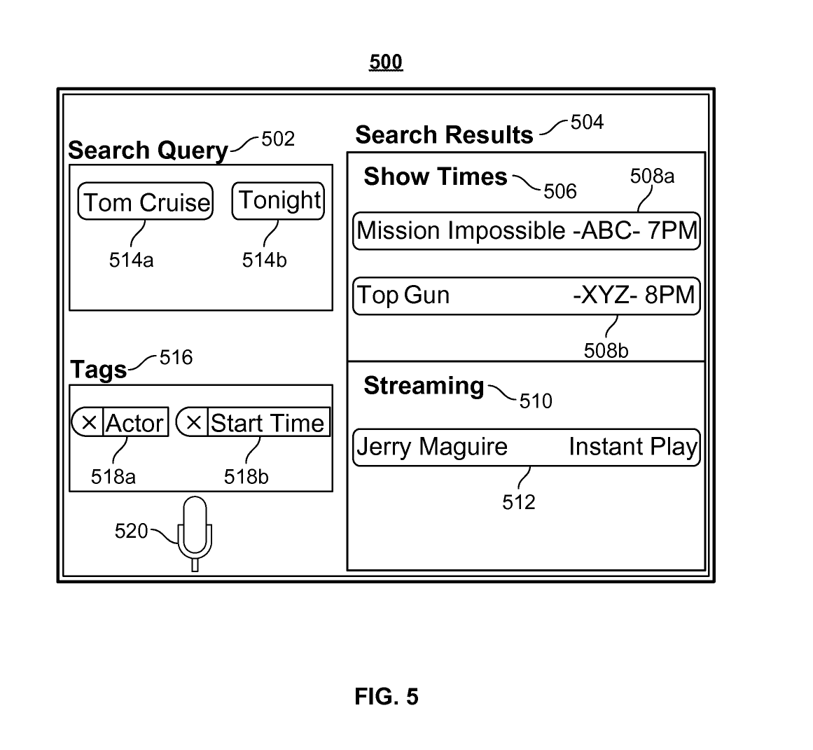

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

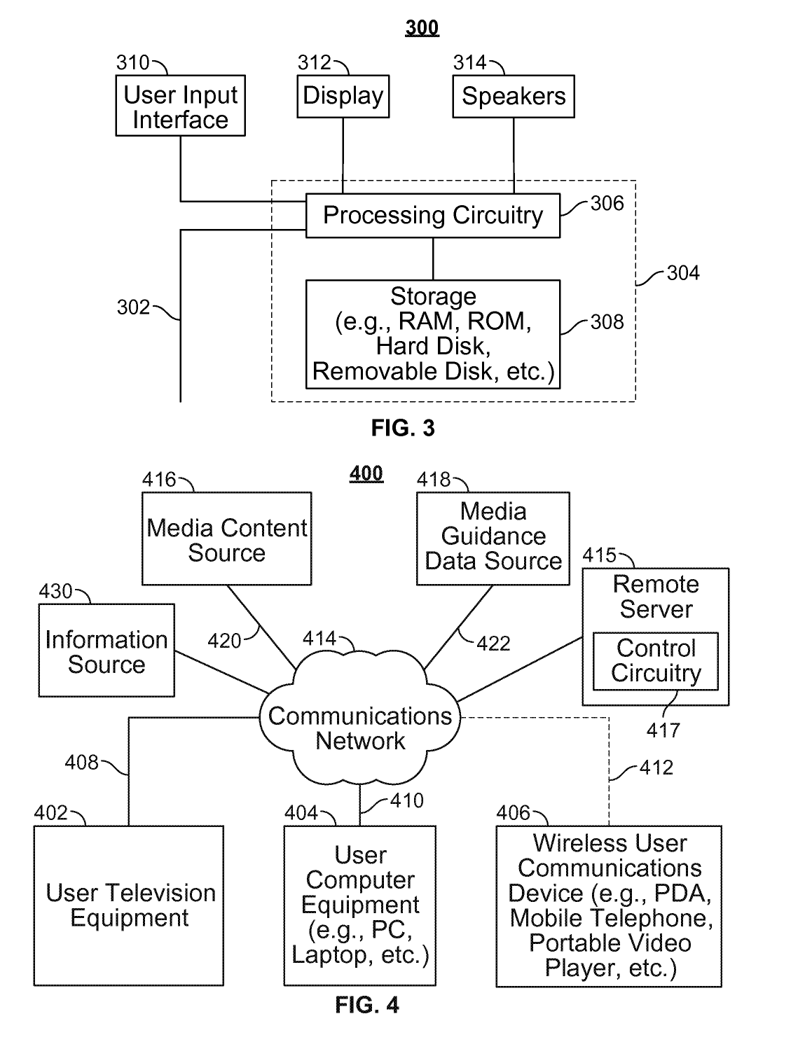

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 312 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server 415. For example, media guidance applications may be implemented partially as a client application on control circuitry 304 of user equipment device 300 and partially on a remote server 415 as a server application (e.g., media guidance data source 418) running on control circuitry 417 of remote server 415. When executed by control circuitry 417 of the remote server (such as media guidance data source 418), the media guidance application may instruct the control circuitry 417 to generate the guidance application displays and transmit the generated displays to the user equipment devices. The server application may instruct control circuitry 417 of the media guidance data source 418 to transmit data for storage on the user equipment. The client application may instruct control circuitry 304 of the receiving user equipment to generate the guidance application displays.

In some embodiments, the server application executed by control circuitry 417 of remote server 415 may be a context classification application that determines contextual information related to searches performed by a user. The contextual information may include, but need to be limited to, search queries submitted by a user, identifiers assigned to such search queries, and metadata related to search queries. The contextual information may further include user input, submitted in response to previous searches, that confirms or rejects contextual information attributed to the previous searches by the user equipment device. For example, if a user previously determined that a first and a second search query should be merged, that confirmation may be stored as contextual information together with the search queries. Similarly, the contextual information may further include instances in which a user determined that two search queries should be disassociated.

As part of determining contextual information, remote server 415 may communicate with one or more other entities, such as speech recognition engine 704 and search engine 708. Speech recognition engine 704 may further communicate with speech recognition database 710, and search engine 708 may further communicate with media asset database 716. Remote server 415, as part of executing context classification engine 706, may further communicate with knowledge graph 712 and context database 714. For example, control circuitry 417 of remote server 415 may assign a first identifier to a first search query based on information retrieved from context database 714. Control circuitry 417 of remote server 415 may further determine a plurality of identifiers, based on a mapping retrieved from knowledge graph 712, that associates the first identifier with the plurality of identifiers, wherein each of the plurality of identifiers corresponds to a search query that has previously been merged by the user with the first search query to perform a search. Control circuitry 417 may then assign a second identifier to a second search query received from the user, and determine whether to merge the first search query and the second search query based on whether the second identifier is among the plurality of identifiers.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

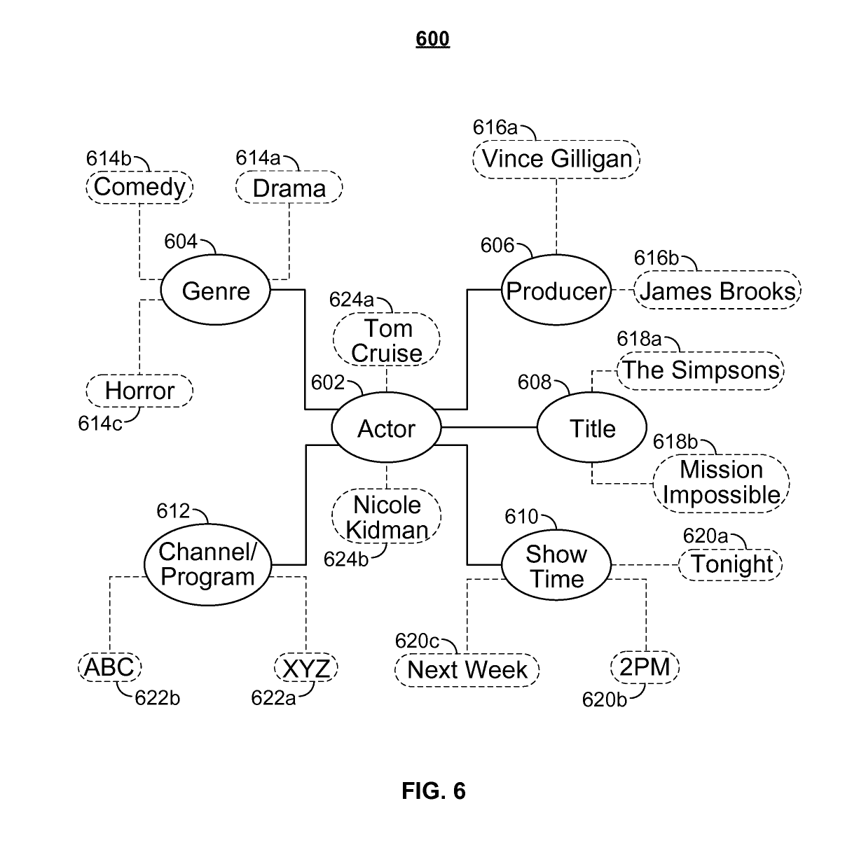

FIG. 5 shows an illustrative graphical user interface 500 that may be used to determine whether to merge search queries based on contextual information, in accordance with some embodiments of the present disclosure. As discussed in relation to FIG. 3, control circuitry 304 of user equipment device 300 may generate for display on display 312 graphical user interface 500 in response to receiving a request from the user to perform a search. Graphical user interface 500 may include a search query window 502, a tag window 516, and a search result window 504. Search result window 504 may be split into several segments, according to the type of content displayed in the window. For example, search result window 504 may contain a show times window 506, corresponding to media assets that are transmitted on broadcast channels, and a streaming window, corresponding to media assets that can be streamed from remote server 415 or other form of storage medium.

In some embodiments, control circuitry 304 updates graphical user interface 500 in response to receiving voice input from the user. Voice input indicator 520 may be used to facilitate the interaction between graphical user interface 500 and the user. For example, control circuitry 304 may generate for display voice input indicator 520 to alert the user that voice commands may be used as input. Control circuitry 304 may then receive a command that indicates that a voice command is about to be issued by the user, for example, by pressing a button on a remote control, touching the screen at a substantially similar position as voice input indicator 520, or by using other suitable means. The input may also correspond to a control command spoken by a user, such as “Command” or a similar input. Upon receiving such user input, control circuitry 304 may receive voice data that is processed using automatic speech recognition techniques and translated to text format, such as a text string, that can be more easily processed further by control circuitry 304.

In some aspects, control circuitry 304 may receive a search command from the user that includes a first search query. In response to receiving the search command, control circuitry 304 may cause graphical user interface 500 to display a search query window 502 that includes a textual representation of the search query (e.g., search query 514a, a search for media assets staring the actor Tom Cruise). Control circuitry 304 may abbreviate the search query in order to present it to the user in more compact form, such as by displaying the text “Tom Cruise” instead of “media assets Tom Cruise” or a similar form of search query. Control circuitry 304 may further assign an indicator to the search query that represents a category, entity, or generic representation of the search query. For example, a search query for “Tom Cruise” may be assigned the identifier “actor,” “name,” or “person.” Control circuitry 304 may cause graphical user interface 500 to display the assigned identifier in tag window 516. For example, identifier 518a (e.g., “actor”) may be assigned to search query 514a (e.g., “Tom Cruise”).

In some embodiments, identifier 518a may include a check mark icon. Control circuitry 304 may cause the display of the check mark icon to inform the user that the assignment of identifier 518a may be overridden or altered. For example, control circuitry 304 may change the identifier in response to receiving an indication that the user touched an area of display screen 312 that is sufficiently close to the check mark icon, by receiving a command issued by the user via a remote control, or by other suitable means. In response to receiving such user input, control circuitry 304 may modify the assignment of identifier 518a, such as by presenting another identifier in place of identifier 518a. Alternatively, control circuitry 304 may remove indicator 518a from the display and prompt the user to provide input that assigns an alternate identifier, such as by prompting the user to issue an identifier to be assigned as a voice command. In yet another embodiment, control circuitry 304 may delete both search query 514a, and identifier 518a and prompt the user to reenter the search query, either through a voice command, or using any other suitable means.

In some aspects, control circuitry 304 may perform a search for media assets that match search query 514a received from the user. Various types of media assets, such as broadcast programs or media assets available on-demand, may be searched and displayed in search results window 504 of graphical user interface 500. Media assets that are identified by control circuitry 304 as matching search query 502 may also be grouped according to their type, such as by showing broadcast programs in show time segment 506 and media assets that are available on-demand in streaming segment 510. Although not shown in FIG. 5 to avoid overcomplicating the drawing, control circuitry 304 may generate for display additional media type segments, such as for media assets stored locally on a hard disk, or other suitable types of media assets. In some aspects, control circuitry 304 may automatically perform a search as soon as search query 514a is received from the user. In other embodiments, control circuitry 304 may not perform a search for media assets matching search query 514a until an explicit search command is received from the user.

In some aspects, in response to receiving search query 514a and possibly performing a search based on search query 514a, control circuitry 304 may receive a second search query 514b from the user. For example, search query 514b may correspond to media assets that are available within a predefined time interval, such as “tonight.” Similar to the processing performed by control circuitry 304 in relation to search query 514a, search query 514b may be shown in textual from as part of graphical user interface 500. Control circuitry 304 may further assign a second indicator to the second search query, such as indicator 518b. For instance, if the second search query issued by the user corresponds to media assets being shown tonight, indicator 518b may denote that control circuitry 304 interpreted this search query to represent a start time of a media asset.

In some aspects, control circuitry 304 may determine, in response to receiving a second search query, whether to merge the first search query and the second search query, or whether to disassociate the search queries by performing a new search solely based on the second search query. Control circuitry 304 may make this determination based on contextual information inferred from the first search query and the second search query. For example based on identifier 514a, control circuitry 304 may identify other identifiers that are related to identifier 514 in a search query mapping. Next, for each of the related identifiers, it may be determined whether the related identifier has previously been merged with identifier 514 to perform a search. If control circuitry 304 determines that a merge has previously occurred, the related identifier may be added to a candidate set of identifiers. Otherwise, if control circuitry 304 determines that the related identifier has not been used previously in conjunction with identifier 514a to perform a search, the related identifier may not be added to the candidate set. Control circuitry 304 may perform the above processing for each identifier that is related to identifier 514a. Once control circuitry 304 receives search query 514b, control circuitry 304 may determine whether search query 514b is contained in the candidate set. In some aspects, if control circuitry 304 determines that the second identifier is contained in the set of candidate identifiers, control circuitry 304 may determine that the first search query should be merged with the second search query. Alternatively, if control circuitry 304 determines that the second identifier is not contained in the set of candidate identifiers, control circuitry 304 may, at step 840, perform a search that is based only on the second search query, i.e., control circuitry 304 may determine that the first search query and the second search query should not be merged but instead remain separate.

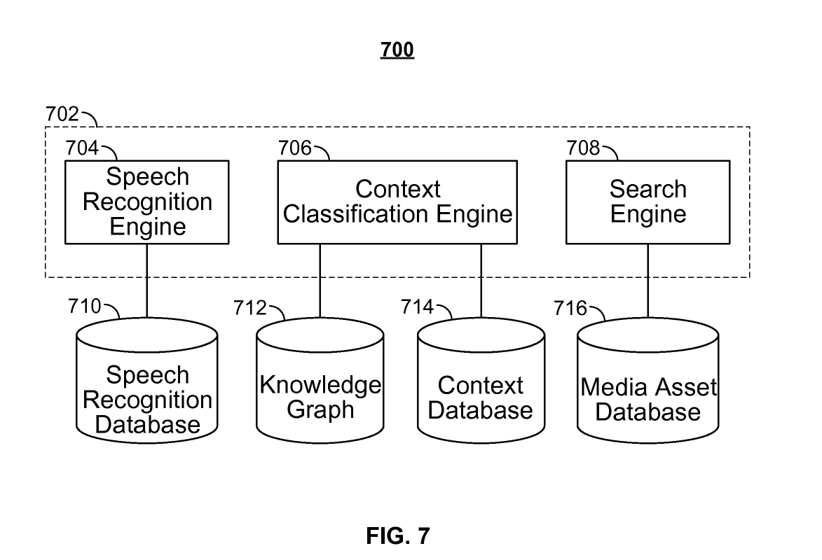

FIG. 6 shows a knowledge graph 600 that represents contextual information used in determining whether to merge search queries, in accordance with some embodiments of the disclose. Knowledge graph 600 may consist of a possibly large number of entities that are represented as nodes in the graph. For example, knowledge graph 600 may contain, among others, nodes 602, 604, 606, 608, 610, and 612. The nodes of knowledge graph 600 may be connected by edges, and the presence of an edge in the graph may represent that there is an association between the entities represented by the nodes in the graph. For example, the edge connecting node 602 (i.e., “actor”) with node 608 (i.e., “title”) may illustrate the availability of contextual information between a media asset's title and actors features in the media asset. In some implementations, an edge in knowledge graph 600 denotes that an association between the two entities connected by the edge is present. Conversely, the absence of an edge in knowledge graph 600 between two entities may denote that no association exists. For example, nodes 602 and 604 may be connected by an edge, illustrating that a search query related to a genre of a media asset is likely to come up in a similar context as a search query related to an actor being featured in the media asset. Accordingly, control circuitry 304 may determine, based on the presence of an edge between nodes 602 and 604, that a search query related to a genre of a media asset should be merged with another search query related to an actor being featured in the media asset.

Similarly, control circuitry 304 may determine that two search queries are likely not associated with the same context when to nodes are not connected by an edge in knowledge graph 600. For example, as shown in FIG. 6, node 604 and node 612 are not connected by an edge in knowledge graph 600, because it may be unlikely that a search related to a genre of a media asset is associated with the same context as a search related to a channel or program associated with the media asset. Accordingly, because there is no edge between nodes 604 and 612, if control circuitry 304 receives two search queries corresponding to a genre of a media asset and a channel/program of a media asset, respectively, control circuitry 304 may determine that the search query related to the genre and the search query related to the channel/program are likely unrelated, and may therefore perform a search solely based on the second search query (e.g., the search related to the channel/program of the media asset).

In other implementations, although not shown in FIG. 6 to avoid overcomplicating the drawing, an edge between two entities in the knowledge graph may be associated with a weight (e.g., a real number, possibly normalized to a predefined interval) that reflects how likely the nodes connected by the edge are to be associated in a given context. For example, a relatively high weight may serve as an indication that there is a strong link between the nodes connected by the edge. Conversely, a relatively low weight may indicate that there is only a weak association between the nodes connected by the edge.

In some aspects, knowledge graph 600 may include nodes of various degree. For example, knowledge graph 600 may include nodes of a first degree, such as nodes 602-612, and nodes of a second degree, such as nodes 614-622. Nodes of a first degree may correspond to broad categories, such as “actor,” “genre,” “producer,” “title,” “show time,” and “channel/program.” Nodes of a second degree may correspond to terms with a more narrow meaning, such as specific instances that fall under the broad categories represented by the first degree nodes. For example, “actor” node 602 may be connected with node 624a (“Tom Cruise”) and node 624b (“Nicole Kidman”). Node 602 may be connected with many more nodes, even though only nodes 624a and 624b are shown in FIG. 6 to avoid overcomplicating the drawing. Similarly, “title” node 608 may be connected with node 618a (“The Simpsons”), node 618b (“Mission Impossible”), and other nodes (not shown). In some embodiments, each of the second degree nodes may be connected to only a single first degree node, which may result in a structured graph that is more easily traversed by control circuitry 304 when a search needs to be performed. Alternatively, second degree nodes may be connected to more than a single first degree node, e.g., to accommodate cases in which the concept represented by the second degree may need to be associated with more than a single first degree node (e.g., a person who is both an actor and a producer).

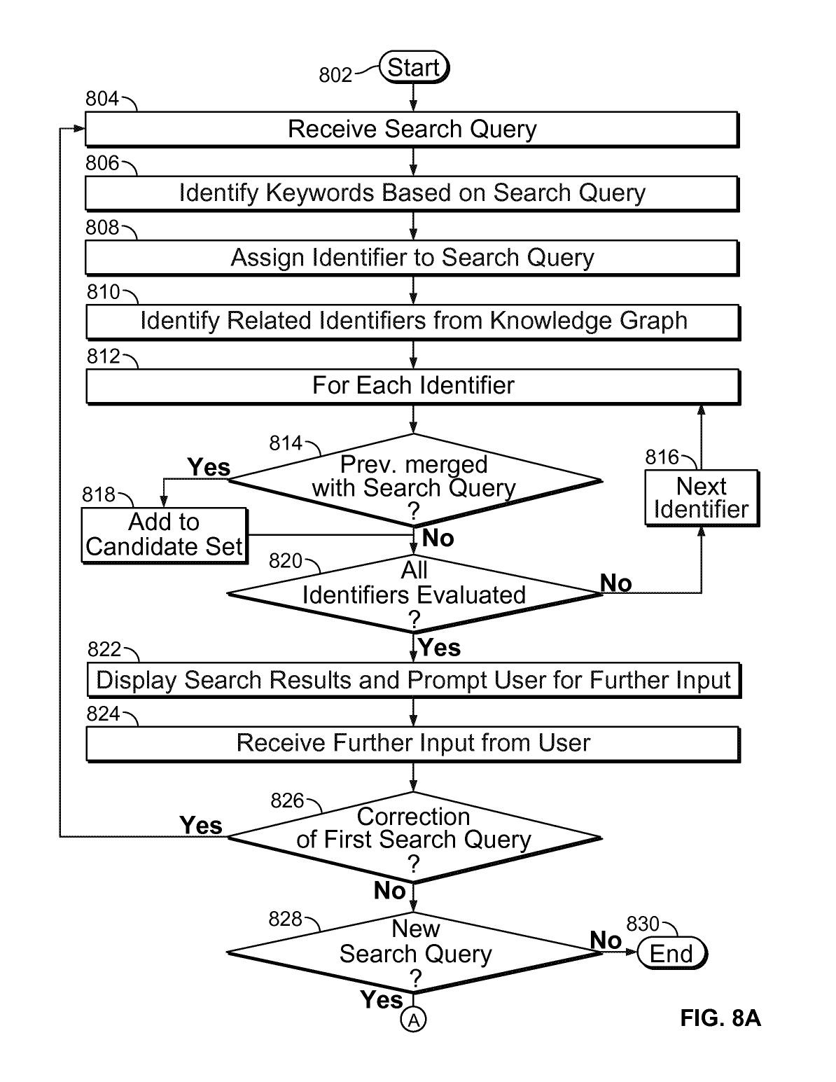

FIG. 7 is an illustrative block diagram 700 of an interactive media system 700 for determining whether to merge search queries based on contextual information, in accordance with some embodiments of the disclosure. Interactive media system 700 may comprise several components that are located on remote server 702. Remote server 702 may be remote server 415, as shown in relation to FIG. 4, with control circuitry 417. In some embodiments, remote server 702 may host several components to perform automatic speech recognition, classify contextual information related received input, and perform a search. For example, remote server 702 may include speech recognition engine 704, context classification engine 706, and search engine 708. As referred to herein, operations performed by speech recognition engine 704, context classification engine 706, and search engine 708 should be understood to mean operations that are executed by control circuitry 417. For example, speech recognition engine 704 may be installed on remote server 702 or 415 as a piece of software code. Control circuitry 417 may then execute the software corresponding to speech recognition engine 704 to carry out the functionality assigned to speech recognition engine 704 (e.g., to perform automatic speech recognition of speech input).

Speech recognition engine 704 may be an application that receives a speech segment as input (e.g., in form of an audio file or a similar digital representation) and generates a text string as output that captures the content of the speech segment. In some embodiments, speech recognition engine may receive the speech segment from remote server 702, which in turn may receive the speech segment from control circuitry 304. In some embodiments, speech recognition engine 704 may be connected to speech recognition database 710 that stores the vocabulary of a language spoken by a user (e.g., English). Speech recognition database 710 may further include a vocabulary of reserved words that represent commands available to the user. For example, the word “Command” may be reserved and represent the beginning of a command that is available to the user. For example, the word “Command” followed by “Search” may indicate that the user intends to perform a search of media assets.

Context classification engine 706 may be responsible for assigning identifiers to search queries received from speech recognition engine 704. In some embodiments, context classification engine 706 may first identify keywords associated with the search queries, for example, by using context database 714. Context database 714 may contain listings of keywords that frequently occur in search for media assets. Context database 714 may also contain rules that may be used by context classification engine 706 to extract keywords from the search queries. For example, one rule may specify when articles, such as “the” and “a” may be deleted.” Another rule may specify words that should be removed because they are clear from context. For instance, the search query “media asset Tom Cruise” may be reduced to “Tom Cruise,” because it may be clear from context that any search pertains to media assets.

In response to identifying keywords based on the received search query, context classification engine 706 may assign an identifier to the search query. Context classification engine 706 may select the identifier based on the search query from a predefined set of candidate identifiers. The identifiers included in the candidate set may have a varying degree of specificity. For example, in a first embodiment, the set of identifiers may only include first degree nodes in knowledge graph 600, as is discussed in relation to FIG. 6. These identifiers may include “actor,” “genre,” “channel/program,” “title,” “producer,” and “show time.” Other suitable identifiers that are typically include in media asset metadata may also be included. Context classification engine 706 may assign such relatively broad terms because these terms may provide appropriate contextual information based on which the search query is issued. For instance, if a user is looking for media assets that feature the actor Tom Cruise, then the identifier “actor” may broadly capture the context within which the user has issued the search query. Similarly, if control circuitry 304 receives a command from the user to search for media assets with a start time in the evening (e.g., in response to receiving a search query “what's on this evening”), the identifier “start time” may broadly capture the context of the search.

In a second embodiment, identifiers assigned to the search query may be associated with a larger degree of specificity. For instance, the identifiers may be substantially similar to the keywords that are being extracted by control circuitry 304 from speech data provided by the user. For example, in response to receiving the search query “what's on tonight,” control circuitry 304 may assign the identifier “tonight” instead of “start time.” In another example, if control circuitry receives the search query “show me a movie starring Tom Cruise,” control circuitry 304 may assign the identifier “Tom Cruise” rather than actor. The larger degree of specificity associated with this second exemplary embodiment may provide more accurate contextual information, at the expense of failing to make associations that could be made in the case of using broader identifiers.

Context classification engine 706 may further be connected to knowledge graph database 712. Upon assigning an identifier to the search query received from speech recognition engine 704, context classification engine may access knowledge graph database 712 to determine if a node exists in knowledge graph 600 that corresponds to the identifier. If such a node exists, context classification engine 706 may next identify other identifiers from knowledge graph database 712 that are related to the identifier, e.g., by considering all the edges that connected to the node corresponding to the identifier. Next, context classification engine 706 may perform processing for each of the related nodes determined from the knowledge graph. The further processing may include determining whether the a specific related identifier has previously been merged with the first identifier to perform a search. If context classification engine 706 determines that the current identifier has previously been merged with the first identifier to perform a search, the current identifier is added to a candidate set of identifiers. Otherwise, if control circuitry 304 determines that the current identifier has not been used previously with the first identifier to perform a search, the current identifier may not be added to the candidate set.

In some embodiments, upon receiving a second search query, context classification engine 706 may assign a second identifier to the second search query. Context classification engine 706 may then determine whether the second identifier is contained in the set of candidate identifiers. If context classification engine 706 determines that the second identifier is contained in the set, context classification engine 706 may determine that the first search query and the second search query should be merged. Alternatively, if the second identifier is not contained in the candidate set, context classification engine 706 may determine that the first search query and the second search query should be disassociated.

Search engine 708 may be responsible for searching a plurality of media assets based on one or more search queries. In some embodiments, search engine 708 may be connected to media asset database 716 that contains media assets, metadata associated with media assets, and other information suitable for locating a media asset among the plurality of media assets based on search queries. Search engine 708 may receive a number of search queries as input, and provide a plurality of media asset listings as output. Control circuitry 304 may generate a display of the plurality of media asset listings in graphical user interface 500, as is discussed in relation to FIG. 5.

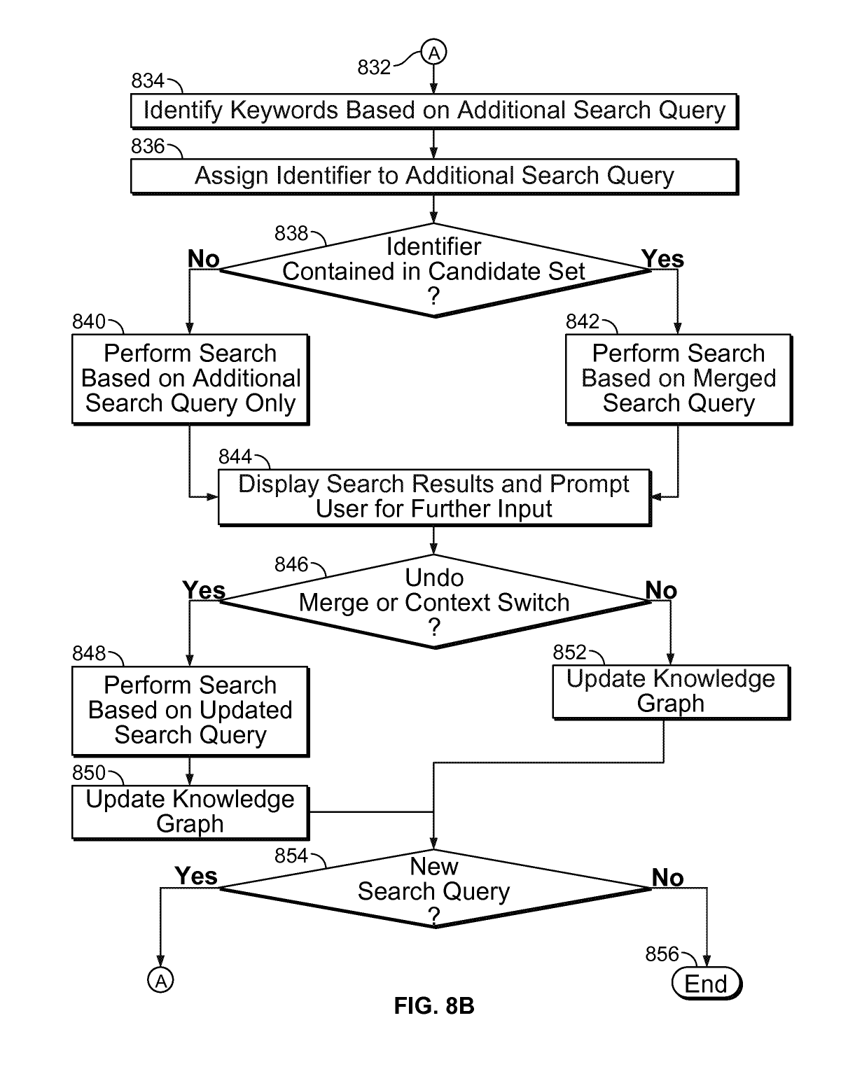

FIGS. 8A and 8B show a flow chart of a process 800 including illustrative steps involved in determining whether to merge search queries based on contextual information, in accordance with some embodiments of the present disclosure. In some embodiments, process 800 may be performed by control circuitry 304. In other embodiments, some steps of process 800 may be performed by a combination of control circuitry 304 and control circuitry 417 or 702, as is discussed in relation to FIG. 7. For example, speech recognition engine 704, context classification engine 706, or search engine 708 may be executed on remote server 702 and remotely accessed or controlled by control circuitry 304.

Process 800 may start at step 802. At step 804, control circuitry 304 may receive a search query from a user, such as search query 514a discussed in relation to FIG. 5. Control circuitry 304 may receive the search query in various forms. In a first embodiment, control circuitry 304 may receive a string of text entered by the user using a keyboard, by pressing buttons on a remote control unit, by pressing buttons associated with an on-screen keyboard, or by entering text in any other suitable way. In a second embodiment, control circuitry 304 may receive voice commands from the user in the form of speech data. The speech data may contain predefined voice commands (e.g., to denote that a voice command follows) as well as unrestricted and continuous speech uttered by the user. The speech data may be accompanied by control data, such as information related to a specific button pressed by the user on a remote control before or while providing the speech input. For example, the user may press a first button on a remote control to perform a first function based on the speech data. For example, the user may press a “search” button to perform a search for media assets corresponding to a search query represented by the speech data. Alternatively, the user may press an “action” button to execute a specific function with respect to a command represented by the voice data (e.g., change channels to a broadcast channel whose name is provided in the speech data).

In some aspects, control circuitry 304 may be available to receive a search query at any time, and may continuously look for search queries among input provided to control circuitry 304 (e.g., by continuously monitoring speech input from a microphone). In other aspects, the reception of a search query may be initiated by a trigger, such as a search command being issued by the user. In this case, control circuitry may not need to monitor speech input continuously but rather may look for a search query only in response to receiving a trigger signal.

At step 806, in response to control circuitry 304 receiving a search query from the user, control circuitry 304 may identify keywords based on the received search query. For example, in some aspects, the search query received from the user may contain ancillary words that may not be useful in searching for media assets related to the received search query. For instance, speech data received by control circuitry 304 may correspond to a phrase such as “look for media assets showing Tom Cruise.” While control circuitry 304 may perform automatic speech recognition techniques to translate the speech data into the aforementioned phrase, control circuitry 304 may be able to locate media assets matching the search query more accurately by first identifying keywords from the received search query. For example, “Tom Cruise” may be extracted by control circuitry 304 from the received search and may be used in place of the unabbreviated search query.

In response to identifying keywords based on the received search query, control circuitry 304 may, at step 808, assign an identifier to the search query. Control circuitry 304 may select the identifier based on the search query from a predefined set of candidate identifiers. The identifiers included in the candidate set may have a varying degree of specificity. For example, in a first embodiment, the set of identifiers may only include first degree nodes in knowledge graph 600, as is discussed in relation to FIG. 6. These identifiers may include “actor,” “genre,” “channel/program,” “title,” “producer,” and “show time.” Other suitable identifiers that are typically include in media asset metadata may also be included. Control circuitry 304 may assign such relatively broad terms because these terms may provide appropriate contextual information based on which the search query is issued. For instance, if a user is looking for media assets that feature the actor Tom Cruise, then the identifier “actor” may broadly capture the context within which the user has issued the search query. Similarly, if control circuitry 304 receives a command from the user to search for media assets with a start time in the evening (e.g., in response to receiving a search query “what's on this evening”), the identifier “start time” may broadly capture the context of the search.

In a second embodiment, identifiers assigned to the search query may be associated with a larger degree of specificity. For instance, the identifiers may be substantially similar to the keywords that are being extracted by control circuitry 304 from speech data provided by the user. For example, in response to receiving the search query “what's on tonight,” control circuitry 304 may assign the identifier “tonight” instead of “start time.” In another example, if control circuitry receives the search query “show me a movie starring Tom Cruise,” control circuitry 304 may assign the identifier “Tom Cruise” rather than actor. The larger degree of specificity associated with this second exemplary embodiment may provide more accurate contextual information, at the expense of failing to make associations that could be made in the case of using broader identifiers.

As is discussed in relation to FIG. 5, control circuitry 304 may cause one or more of the search query, extracted keywords, and assigned identifiers to be generated for display in graphical user interface 500. For example, control circuitry 304 may cause the received search query or the extracted keywords to be shown in a search query window 502 (e.g., in form of search query 514a). Control circuitry 304 may further cause the display of the assigned identifier in tag window 516, e.g., in form of identifier 518a. In some aspects, identifier 518a may include a check mark icon. Control circuitry 304 may cause the display of the check mark icon to inform the user that the assignment of identifier 518a may be overridden or altered. For example, For example, control circuitry 304 may change the identifier in response to receiving an indication that the user touched an area of display screen 312 that is sufficiently close to the check mark icon, by receiving a command issued by the user via a remote control, or by other suitable means. In response to receiving such user input, control circuitry 304 may modify the assignment of identifier 518a, such as by presenting another identifier in place of identifier 518a. Alternatively, control circuitry 304 may delete the display of indicator 518a and prompt the user to provide input that assigns an alternate identifier, such as by prompting the user to issue an identifier to be assigned as a voice command. In yet another embodiment, control circuitry 304 may delete both search query 514a, and identifier 518a and prompt the user to reenter the search query, either through a voice command, or any other suitable means.

At step 810, control circuitry 304 may identify other identifiers from the knowledge graph that are related to the identifier assigned to the search query (i.e., the first identifier). In some aspects, control circuitry 304 may determine identifiers related to the first identifier by accessing knowledge graph 600, as discussed in relation to FIG. 7, may be stored in knowledge graph database 712. Control circuitry 304 may access knowledge graph database 712 through context classification engine 706, possibly through remote server 706. However, knowledge graph database 712 and context classification engine 706 may also be stored locally in user equipment device 300, such as in memory 308. As part of accessing knowledge graph 600, control circuitry 304 may first locate a node (e.g., “actor”) that is associated with the first search query (e.g., “Tom Cruise”). Next, control circuitry 304 may determine all nodes that are connected to the present node (e.g., “actor”), i.e., all those nodes that share an edge in the graph with the present node. Using knowledge graph 600 in FIG. 6 as an example, these nodes may be node 604 (“genre”), node 606 (“producer”), node 608 (“title”), node 610 (“show time”), and node 612 (“channel/program”). The nodes corresponding to related identifiers thus determined may be added to a list or set by control circuitry 304 for further processing.

At step 812, control circuitry 304 may perform processing for each of the nodes determined from the knowledge graph. The further processing may include, at step 814, determining whether the a specific related identifier has previously been merged with the first identifier to perform a search. If control circuitry 304 determines that the current identifier has previously been merged with the first identifier to perform a search, the current identifier is added to a candidate set of identifiers at step 818. Otherwise, if control circuitry 304 determines that the current identifier has not been used previously with the first identifier to perform a search, the current identifier may not be added to the candidate set.

Control circuitry 304 may perform the above processing for each identifier that is related to the first identifier. At the end of processing each of the related identifiers, control circuitry 304 may determine, at step 820, whether all of the related identifiers have been considered. If control circuitry 304 determines that this is the case, control circuitry 304 proceeds with step 822; otherwise, control circuitry considers the next related identifier at step 816.

At step 822, control circuitry 304 may perform a search based on the received search query. In response to performing the search, control circuitry 304 may generate a display of the search results. In some aspects, control circuitry may cause graphical user interface 500 to be generated for display on display screen 312. As is discussed in relation to FIG. 5, graphical user interface 500 may include a search query window 502 that contains the received search query, a tag window 516 that contains the identifier determined by control circuitry 304, and search results window 504, which may include a show time segment 506 and a streaming segment 510. In some embodiments, control circuitry 304 may further prompt the user for further input.

In response to prompting the user for further input, control circuitry 304 may receive various forms of input at step 824. For example, control circuitry 304 may receive a second search query to add or modify the search, select one or more search results shown in search results window 504, or modify the assignment of indicators shown in tag window 516. At step 826, control circuitry may determine whether the further input received from the user corresponds to a correction of the first search query. For example, upon seeing the display of the search query and search results in graphical user interface 500, the user may realize that the automatic speech recognition process has misdetected the search query provided by the user. If control circuitry 304 determines, at step 826, that the user input corresponds to a correction of the first search query, process 800 may receive a new search query and process 800 may resume at 804. Alternatively, if control circuitry 304 determines, at step 826, that the user input does not correspond to a correction of the first search query, process 800 may resume at step 828.

At step 828, control circuitry 304 may determine whether the input received from the user corresponds to a new search query. If control circuitry 304 determines that the input received from the user does not correspond to a new search query, process 800 may terminate at step 830. Otherwise, if control circuitry 304 determines that the user input corresponds to a new search query, process 800 may resume at step 832 in FIG. 8B.

At step 834, control circuitry 304 may identify keywords associated with the new search query. In some aspects, as discussed in relation to step 806, the additional search query may contain ancillary words that may not be useful in searching for media assets related to the new search query. For instance, speech data received by control circuitry 304 may correspond to a phrase such as “look for media assets showing Tom Cruise.” While control circuitry 304 may perform automatic speech recognition techniques to translate the speech data into the aforementioned phrase, control circuitry 304 may be able to locate media assets matching the search query more accurately by first identifying keywords from the received search query. For example, “Tom Cruise” may be extracted by control circuitry 304 from the received search and may be used in place of the unabbreviated search query.

In response to identifying keywords based on the new search query, control circuitry 304 may, at step 836, assign a second identifier to the search query. As is discussed in relation to in relation to 808, control circuitry 304 may select the second identifier based on the new search query from a predefined set of candidate identifiers. The identifiers may have a varying degree of specificity. For example, in one implementation, the candidate identifiers may correspond to nodes in knowledge graph 600 of FIG. 6.

At step 838, control circuitry 304 may determine whether the second identifier is contained in the set of candidate identifiers, determined in step 818. For example, control circuitry 304 may have determined at step 818 that the identifier “actor” is related to the identifiers “genre,” “producer,” “title,” “show time,” and “channel/program,” such as by identifying all nodes that are connected to “actor” node 602 in knowledge graph 600. Accordingly, because an edge between two nodes in knowledge graph 600 implies that a first search query, associated with the first node, and a second search query associated with the second node have previously been merged by the user while performing a search, the aforementioned identifiers, “genre,” “producer,” “title,” “show time,” and “channel/program,” may have been added to set of candidate identifiers at step 818. At step 838, based on the second identifier determined from the second search query, control circuitry 304 may determine whether the second identifier is equal to any of the identifiers in the set of candidate identifiers. For instance, if the user's first search query corresponded to “Tom Cruise” (and was therefore associated with the identifier “actor”) and the second search query corresponded to “tonight” (and was therefore associated with the identifier “show time”), then control circuitry 304 may determine that the identifier is contained in the set of candidate identifiers.

Alternatively, in another example, the user may have entered a first search query for “comedy,” which was associated with the identifier “genre” by control circuitry 304. Next, control circuitry 304 may receive a second search query corresponding to a broadcast channel “XYZ,” which may be associated with the identifier “channel/program” by control circuitry 304. Further, based on the first identifier, control circuitry 304 may have determined a candidate set that includes only the “actor” identifier, because “genre” node 604 is only connected to “actor” node 602 in knowledge graph 600. Accordingly, in this example, control circuitry 304 may determine that the second identifier (i.e., “channel/program”) is not contained in the set of candidate identifiers.

In some aspects, if control circuitry 304 determines that the second identifier is contained in the set of candidate identifiers, control circuitry 304 may determine that the first search query should be merged with the second search query. Alternatively, if control circuitry 304 determines that the second identifier is not contained in the set of candidate identifiers, control circuitry 304 may, at step 840, perform a search that is based only on the second search query, i.e., control circuitry 304 may determine that the first search query and the second search query should not be merged but instead remain separate.

In addition to determining whether the second identifier is contained in the set of candidate identifiers, control circuitry 304 may take into account weights associated with edges in knowledge graph 600 to determine whether or not to merge the first search query and the second search query. For example, as discussed in relation to FIG. 6, control circuitry 304 may receive a first search query that is assigned a first identifier (e.g., “actor”). In response to assigning the identifier, control circuitry 304 may identify a node in the knowledge graph that corresponds to this identifier (e.g., node 602). Next, control circuitry 304 may determine the set of candidate identifiers by identifying all nodes that are connected to the identified node by an edge. In some aspects, the edge that connects the node corresponding to the first identifier with each of the nodes corresponding to one of the identifiers in the set of candidate identifiers, may be associated with a weight. The weight may be a real number, possibly normalized to a predefined interval, such as the closed interval ranging from zero to one. A relatively large weight associated with an edge may indicate that there is a comparably strong association between the nodes connected by the edge, and therefore a comparably strong association between their respective identifiers. Conversely, a relatively small weight associated with an edge may indicate that the association between the corresponding nodes, and between their respective identifiers, is comparably weak.

In some aspects, control circuitry 304 may take into account the weights associated with the identifiers contained in the set of candidate identifiers when determining whether to merge the first search query with the second search query. For example, control circuitry 304 may use a predetermined or dynamic threshold. Upon identifying the second identifier in the set of candidate identifiers, control circuitry 304 may determine the weight, such as by retrieving the weight from the knowledge graph using context classification engine 706 and knowledge graph database 712. Control circuitry 304 may then compare the determined weight with the predefined or dynamic threshold. If the weight is above the threshold, control circuitry 304 may determine to merge the first search query with the second search query. Alternatively, if the weight is below the threshold, control circuitry 304 may determine to keep the first search query and the second search query separate, e.g., by performing a new search based upon only the second search query.

At step 844, control circuitry 304 may generate a display of the new search results determined at either step 840 or step 842. In some implementations, control circuitry 304 may cause the new search results to be displayed in form of graphical user interface 500. For example, control circuitry 304 may add a textual representation of the second search query in search query window 502, e.g., in form of search query 514b. Similarly, the second identifier determined by control circuitry 304 may be displayed using identifier 518b in tag window 516. The new search results obtained by control circuitry 304 at either step 840 or step 842 may be displayed by control circuitry 304 in search results window 504 of graphical user interface 500, such as in show times segment 506 or streaming segment 510. Control circuitry 304 may further display an indication of whether the first search query and the second search query have been merged. For example, if more than a single identifier is displayed in tag window 516, such as identifier 514a and identifier 514b, this may indicate that the first search query (e.g., search query 514a) and the second search query (e.g., search query 514b) have been merged.

At step 846, control circuitry 304 may receive input from the user to either undo the merge of the first search query and the second search query (assuming that control circuitry 304 previously determined to merge the search queries) or to merge the first search query and the second query (assuming that control circuitry 304 previously determined not to merge the search queries). Control circuitry 304 may receive this input in form of a voice command, by receiving an indication that the user has pressed a button on a remote control device, or by any other suitable means. For example, control circuitry 304 may receive voice input from the user and may determine that the voice input corresponds to a command to undo an incorrect merge or context switch of the first search query and the second search query. In some aspects, control circuitry 304 may make this determination, at least in part, by differentiating between voice input that corresponds to data (e.g., a new search query) and voice input that corresponds to control commands (e.g., the user instruction to undo the merge or context switch).

If, at step 848, control circuitry 304 determines that the user issued a command to undo the merge of the first search query and the second search query, control circuitry 304 may perform a new search in accordance with the received user command. For example, if control circuitry 304 previously merged the search queries but received an indication to undo the merge, then control circuitry 304 may perform the new search solely based on the second search query. Alternatively, if control circuitry 304 previously separated the search queries but received an indication to merge them, then control circuitry 304 may perform the new search based on both the first search query and the second search query. Control circuitry 304 may further, at step 850, update knowledge graph 600 in accordance with the command received from the user. For example, in case of undoing a merge, knowledge graph 600 may be updated to remove the association between the nodes in the knowledge graph. Conversely, in case of undoing a disassociation of the search queries, knowledge graph 600 may be updated to include an edge between the nodes corresponding to the first search query and the second query.

Even if control circuitry 304 does not receive a command to undo the merge or disassociation of the first search query and the second search query, control circuitry 304, at step 852, may still update knowledge graph 600. In some aspects, control circuitry 304 may take the lack of a user command as an implicit confirmation that the merge or disassociation of the first search query and the second search query has been performed in accordance with the user's preference. Alternatively, control circuitry 304 may only update knowledge graph 600 when it receives explicit confirmation from the user, such as in form of a user command that confirms that the merge or disassociation of the first search query and the second search query has been performed correctly.

In some aspects, updating knowledge graph 600 may further include modifying weights that are assigned to edges in knowledge graph 600. For example, if control circuitry 304 receives a user input that confirms the merge of a first search query and a second search query, a weight associated with the edge between the nodes corresponding to the first and second search query may be increased by a predefined amount. Alternatively, if control circuitry 304 receives a user command to undo the merge of a first search query and a second search query, control circuitry 304 may decrease the weight associated with that edge.

At step 854, control circuitry 304 may determine whether another search query has been received from the user. If control circuitry 304 determines that a new search query has been received, process 800 may resume at step 832. For example, a third search query may be received, and control circuitry 304 may subsequently determine whether the third search query should be merged with the first and second search queries. Alternatively, control circuitry 304 may determine that the newly received third search query should not be merged. In that case, a new search solely based upon the third search query may be performed. Alternatively, if control circuitry does not receive a new search query from the user, process 800 may terminate at step 856.

It is contemplated that the steps or descriptions of FIGS. 8A-8B may be used with any other embodiment of this disclosure. In addition, the steps and descriptions described in relation to FIG. 8A-8B may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIGS. 8A-8B.

The above-described embodiments of the present disclosure are presented for purposes of illustration and not of limitation, and the present disclosure is limited only by the claims which follow.

Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

1. A method for determining whether to merge search queries used to identify a media asset among a plurality of media assets, the method comprising:
assigning, using control circuitry, a first identifier to a first search query received from a user;
determining a plurality of identifiers based on a mapping that associates the first identifier with the plurality of identifiers, wherein each of the plurality of identifiers corresponds to a search query that has previously been merged by the user with the first search query to perform a search;
assigning, using the control circuitry, a second identifier to a second search query received from the user;
determining whether to merge the first search query and the second search query based on whether the second identifier is among the plurality of identifiers; and
performing a search of the plurality of media assets based on the determining.

2. The method of claim 1, wherein determining whether to merge the first search query and the second search query comprises:
determining to merge the first search query and the second search query if the second identifier is among the plurality of identifiers.

3. The method of claim 1, wherein the mapping is a first mapping and the plurality of identifiers is a first plurality of identifiers, the method further comprising:
determining a second plurality of identifiers based on a second mapping that associates the first identifier with the second plurality of identifiers, wherein each of the plurality of second identifiers corresponds to a search query that has previously been separated by the user from the first search query; and
determining whether to separate the first search query and the second search query based on whether the second identifier is among the second plurality of identifiers.

4. The method of claim 1, wherein the user is a first user, and at least one of the plurality of identifiers corresponds to a search query that has previously been merged with the first search query by a second user.

5. The method of claim 1, wherein the first identifier, the second identifier, and the plurality of identifiers are selected from at least one of a genre, an actor, and a start time of a media asset.

6. The method of claim 1, wherein the first identifier is substantially equal to the first search query and the second identifier is substantially equal to the second search query.

7. The method of claim 1, wherein the mapping that associates the first identifier with the plurality of identifiers is part of a knowledge graph.

8. The method of claim 1, further comprising:
generating for display the first search query, the second search query, and an indication of whether the first search query and the second search query are to be merged into a merged search query;
receiving input from the user that confirms or rejects the merged search query; and
modifying the mapping that associates the first identifier with the plurality of identifiers based on the input from the user.

9. The method of claim 1, wherein the mapping that associates the first identifier with the plurality of identifiers is stored in a user profile of the user.

10. The method of claim 1, wherein the mapping that associates the first identifier with the plurality of identifiers further comprises a plurality of weights corresponding to the plurality of identifiers, and the determining comprises:
determining whether to merge the first search query and the second search query based on the plurality of weights.

11. A system for determining whether to merge search queries used to identify a media asset among a plurality of media assets, the method comprising:
storage circuitry configured to:
store a first search query received from a user and a second search query received from the user; and
control circuitry configured to:
assign a first identifier to the first search query received from the user;
determine a plurality of identifiers based on a mapping that associates the first identifier with the plurality of identifiers, wherein each of the plurality of identifiers corresponds to a search query that has previously been merged by the user with the first search query to perform a search;
assign a second identifier to the second search query received from the user;
determine whether to merge the first search query and the second search query based on whether the second identifier is among the plurality of identifiers; and
perform a search of the plurality of media assets based on the determining.

12. The system of claim 11, wherein the control circuitry determines whether to merge the first search query and the second search query by:
determining to merge the first search query and the second search query if the second identifier is among the plurality of identifiers.

13. The system of claim 11, wherein the mapping is a first mapping and the plurality of identifiers is a first plurality of identifiers, and the control circuitry is further configured to:
determine a second plurality of identifiers based on a second mapping that associates the first identifier with the second plurality of identifiers, wherein each of the plurality of second identifiers corresponds to a search query that has previously been separated by the user from the first search query; and
determine whether to separate the first search query and the second search query based on whether the second identifier is among the second plurality of identifiers.

14. The system of claim 11, wherein the user is a first user, and at least one of the plurality of identifiers corresponds to a search query that has previously been merged with the first search query by a second user.

15. The system of claim 11, wherein the first identifier, the second identifier, and the plurality of identifiers are selected from at least one of a genre, an actor, and a start time of a media asset.

16. The system of claim 11, wherein the first identifier is substantially equal to the first search query and the second identifier is substantially equal to the second search query.

17. The system of claim 11, wherein the mapping that associates the first identifier with the plurality of identifiers is part of a knowledge graph.

18. The system of claim 11, wherein the control circuitry is further configured to:
generate for display the first search query, the second search query, and an indication of whether the first search query and the second search query are to be merged into a merged search query;
receive input from the user that confirms or rejects the merged search query; and
modify the mapping that associates the first identifier with the plurality of identifiers based on the input from the user.

19. The system of claim 11, wherein the mapping that associates the first identifier with the plurality of identifiers is stored in a user profile of the user.

20. The system of claim 11, wherein the mapping that associates the first identifier with the plurality of identifiers further comprises a plurality of weights corresponding to the plurality of identifiers, and the control circuitry is further configured to:
determining whether to merge the first search query and the second search query based on the plurality of weights.

21-50. (canceled)
